(19) United States
(12) Patent Application Publication
(10) Pub. No.: US 2018/0334090 A1
(43) Pub. Date: Nov. 22, 2018

(54) BRAKE COMPONENT ILLUMINATOR AND ILLUMINATION METHOD

(71) Applicant: Ford Global Technologies, LLC, Deraborn, MI (US)

(72) Inventors: Stuart C. Salter, White Lake, MI (US); Paul Kenneth Dellock, Northville, MI (US); James J. Surman, Clinton Township, MI (US); David Brian Glickman, Southfield, MI (US)

(21) Appl. No.: 15/599,575

(22) Filed: May 19, 2017

(51) Int. Cl. B60Q 1/44; F16D 65/00; F16D 65/12; F16D 66/00; B60T 17/22; F21K 2/04

(52) U.S. Cl. CPC B60Q 1/444; F16D 65/0068; F16D 65/12; F16D 2065/132; B60T 17/221; F21K 2/04; F16D 66/00

(57) ABSTRACT

An exemplary vehicle assembly includes, among other things, a brake component configured to emit a first emission, and an indicator adjacent the brake component. The indicator includes a semiconductor layer configured to absorb the first emission and emit a second, different emission. An exemplary vehicle illumination method includes, among other things, absorbing a first emission with a semiconductor layer of an indicator. The first emission is emitted from a brake component. The method further includes emitting a second, different emission from the semiconductor layer.

### TECHNICAL FIELD

This disclosure relates generally to an illumination and, more particularly, to a photo luminescent illuminator associated with a vehicle brake component.

### BACKGROUND

Illumination systems for vehicles are often desirable. The illumination systems include decorative and functional lightning. The illumination systems typically include complex components, such as wires, batteries, lamp devices, and controls.

### SUMMARY

A vehicle assembly according to an exemplary aspect of the present disclosure includes, among other things, a brake component configured to emit a first emission, and an indicator adjacent the brake component. The indicator includes a semiconductor layer configured to absorb the first emission and emit a second, different emission.

A further non-limiting embodiment of the foregoing assembly includes the brake component as a support structure of the indicator.

In a further non-limiting embodiment of any of the foregoing assemblies, the semiconductor layer comprises quantum dots.

In a further non-limiting embodiment of any of the foregoing assemblies, the quantum dots are suspended in polymethylmethacrylate.

In a further non-limiting embodiment of any of the foregoing assemblies, the first emission has a wavelength greater than about 800 nm.

In a further non-limiting embodiment of any of the foregoing assemblies, a wavelength of the first emission is longer than a wavelength of the second emission.

In a further non-limiting embodiment of any of the foregoing assemblies, the indicator is secured directly to a brake rotor.

In a further non-limiting embodiment of any of the foregoing assemblies, the indicator secured directly to a brake caliper.

In a further non-limiting embodiment of any of the foregoing assemblies, the indicator is secured directly to a wheel.

A vehicle illumination method according to an exemplary aspect of the present disclosure includes, among other things, absorbing a first emission with a semiconductor layer of an indicator. The first emission is emitted from a brake component. The method further includes emitting a second, different emission from the semiconductor layer.

In a further non-limiting embodiment of any of the foregoing methods, the semiconductor layer comprises a plurality of quantum dots.

In a further non-limiting embodiment of any of the foregoing methods, the plurality of quantum dots are suspended in polymethylmethacrylate.

In a further non-limiting embodiment of any of the foregoing methods, a wavelength of the first emission is longer than a wavelength of the second emission.

A further non-limiting embodiment of any of the foregoing methods includes securing the indicator directly to a brake rotor.

A further non-limiting embodiment of any of the foregoing methods includes securing the indicator directly to a brake caliper.

A further non-limiting embodiment of any of the foregoing methods includes securing the indicator directly to a wheel.

A further non-limiting embodiment of any forgoing methods includes changing a color of the second emission to indicate a thermal energy level of the brake component.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a close-up view of a wheel area of a vehicle.

FIG. 2 illustrates a perspective view of braking components within the wheel area of FIG. 1.

FIG. 3 is a close-up view of Area III in FIG. 2.

FIG. 4 is a close-up section view of Area IV in FIG. 3.

### DETAILED DESCRIPTION

This disclosure relates to illuminating areas of a vehicle associated with a brake assembly. The illumination can be in response to thermal energy generated during braking.

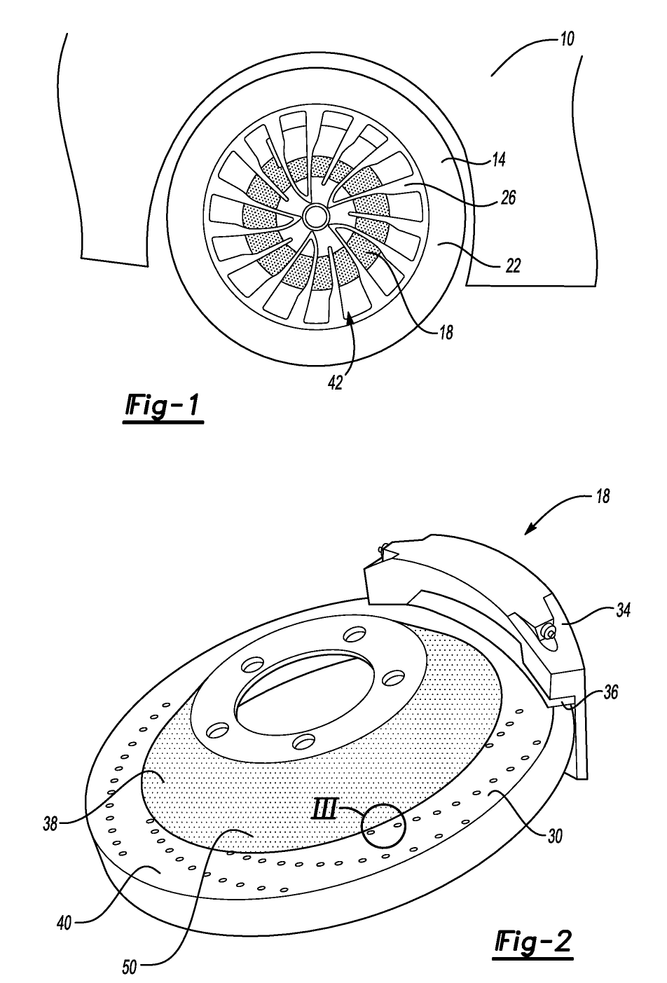

Referring to FIGS. 1 and 2, an example vehicle 10 includes a wheel assembly 14 and a braking assembly 18. The wheel assembly 14 includes, among other things, a tire 22 mounted to a rim 26. The wheel assembly 14 could be a front wheel of the vehicle 10 as shown, or a rear wheel.

In this exemplary non-limiting embodiment, the braking assembly 18 is a disc brake that uses friction to slow rotation of the wheel assembly 14. The braking assembly 18 includes braking components, such as a rotor 30, a caliper 34, and brake pads 36. To slow rotational of the wheel assembly 14, the caliper 34 squeezes the brake pads 36 against the rotor 30.

The rotor 30 includes a coated area 38 and an uncoated area 40. Generally, the coated area 38 is not contacted by the brake pads 36 during braking, and the uncoated area 40 is contacted by the brake pads 36 during braking.

When slowing the wheel assembly 14, the rotating energy of the wheel assembly 14 is converted into thermal energy. The coated area 38 of the rotor 30 illuminates in response to the thermal energy. The emitted light from the coated area 38 is visible through openings 42 in the rim 26. The emitted light provides a visual indication of the thermal energy generated by braking.

Although the rotor 30 is the braking assembly 18 that emits light in this example, other example braking assemblies 18 could generate thermal energy causing light to emit from other areas, such as the calipers 34, or components near the braking assembly 18.

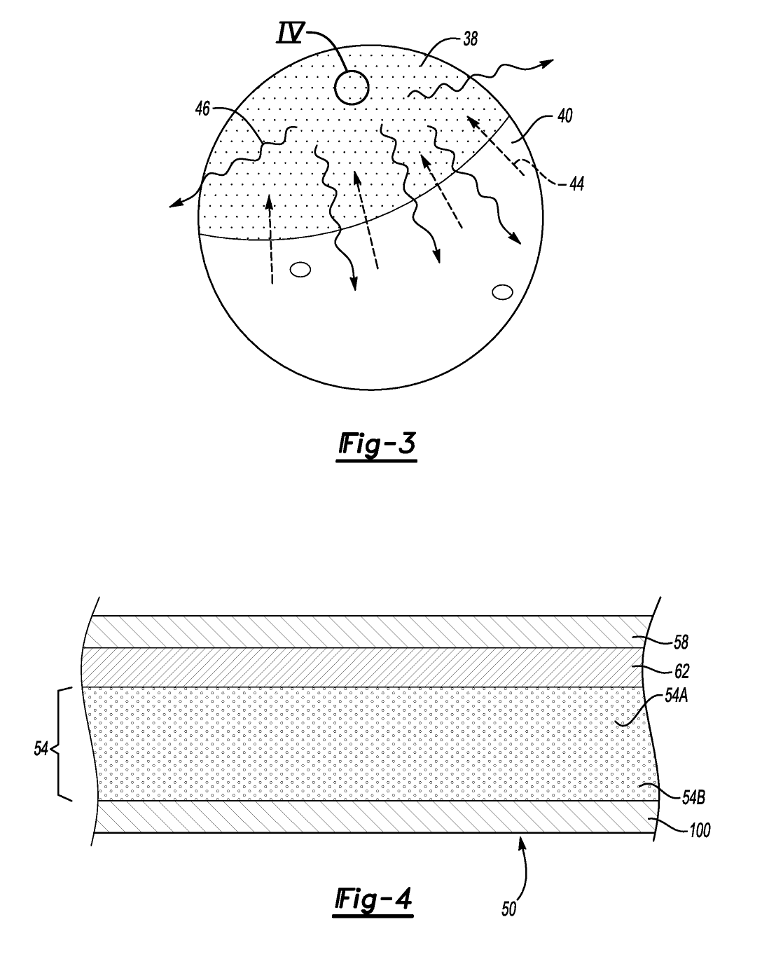

Referring now to FIG. 3 with continuing reference to FIGS. 1 and 2. Thermal radiation generated by the thermal energy within the braking assembly 18 can be considered a first emission 44. The brake assembly 18 is thus configured to emit a first emission 44. As thermal radiation generated by the braking assembly 18 increases due to, for example, more frequent or forceful braking, the wavelength of the first emission can change 44.

As an example, the first emission 44 may be an emission in the infrared band. As thermal energy within the rotor 30 increases, there is a decrease in the wavelength of the first emission 44 such that at ambient room temperature the first emission 44 may have a wavelength between about 50 microns and about 1,000 microns, and at operating temperatures, the first emission 44 may have a wavelength of between about 700 nm and about 1,400 nm. The first emission 44 can have various wavelengths depending on the temperature of the rotor 30.

Referring now to FIG. 4 with continuing reference to FIGS. 1 to 3, to illuminate the braking assembly 18, the coated area 38 of the rotor 30 includes an indicator 50. The indicator 50 includes a semiconductor layer 54 that absorbs the first emission 44 and emits a second, different emission 46 as visible light. The semiconductor layer 54 is, in this example, supported on a support structure 58. The support structure 58 can be the rotor 30 for example.

In some examples, an adhesive layer 62 is positioned between the semiconductor layer 54 and the support structure 58. The adhesive layer 62 can be a clearer pressure-sensitive adhesive or other substantially translucent or transparent adhesive. It will be understood that the adhesive layer 62 is optional. The semiconductor layer 54 could instead be molded directly onto the adhesive layer 62 or a mechanical fastening mechanism could be utilized to secure the semiconductor layer 54.

Again, the semiconductor layer 54 is configured to emit light. The semiconductor layer 54 can be configured to emit light in response to receiving an excitation emission (e.g., the first emission 44). The semiconductor layer 54 can include a binder 54A and a photoluminescent semiconductor material 54B.

The binder 54A may be an optically transparent or translucent material such as polymethylmethacrylate, nylon, polycarbonate, polyester and/or polyvinyl chloride can also be used. The binder 54A is configured to suspend the photoluminescent semiconductor material 54B. The photoluminescent semiconductor material 54B is, in this example, one or more quantum dots. Quantum dots are nanoscale semiconductor devices that tightly confine either electrons or electron holes in all three spatial dimensions and may be photoluminescent. The photoluminescence of a quantum dot can be manipulated to specific wavelengths by controlling the particle diameter of the quantum dots. Quantum dots may have a radius, or a distance half of their longest length, in the range of between about 1 nm and about 10 nm, or between about 2 nm and about 6 nm. Larger quantum dots (e.g., radius of 5-6 nm) emit longer wavelength light resulting in the color of the light being such colors as orange or red. Smaller quantum dots (e.g., radius of 2-3 nm) emit shorter wavelengths resulting in colors such as blue and green. It will be understood that the wavelength of light emitted from the quantum dots may vary depending on the exact composition of the quantum dots. Quantum dots naturally produce monochromatic light. Exemplary compositions of the quantum dots include LaF3 quantum dot nanocrystals that are doped (e.g., coated) with Yb—Er, Yb—Ho and/or Yb—Tm. Other types of quantum dots that can be used include various types of tetrapod quantum dots and perovskite-enhanced quantum dots. It will be understood that one or more types of quantum dots may be mixed or otherwise used in the semiconductor layer 54.

The quantum dot embodiments of the exemplary photoluminescent semiconductor material 54B can be configured to emit light (e.g., the second emission 46) in response to an excitation emission. According to various embodiments, the quantum dots may be configured to emit light by up-converting excitation light. Up-conversion works by absorbing two or more photons of a longer wavelength excitation emission. Once absorbed, the quantum dots may emit one or more photons having a shorter wavelength than the wavelengths of the excitation emission. According to various embodiments, the excitation emission may be infrared light. In such embodiments, the excitation emission (e.g., the first emission 44) may have a wavelength of between about 800 nm and about 1000 nm. In a specific embodiment, the excitation emission may have a wavelength of about 980 nm. A 980 nm wavelength is chosen since red, blue and green emitting colloidal quantum dots of these species can efficiently absorb this wavelength of light. This means the semiconductor layer 54 can emit virtually any color including white, except shades of purple, when charged or excited with infrared light and the proper sized quantum dots are used. It will be understood that quantum dots of different sizes and compositions may be mixed in order to create different lighting colors.

The example brake assembly 18 can reach temperatures that ranging from 400-440° F. during operations. Such temperatures result in thermal energy that is sufficient to fluoresce nanoscale molecules, such as the quantum dots. In an exemplary non-limiting embodiment, quantum dots fluoresce to cause the rotor 30 to emit light.

According to various embodiments, the semiconductor layer 54 may be structurally formed as a film. In a first method of forming the semiconductor layer 54, the photoluminescent semiconductor material 54B may be blended directly into the binder 54A. Next, the mixture of semiconductor material 54B and binder 54A may be extruded into a thin sheet of film.

Another exemplary method of producing the semiconductor layer 54 is to apply a thin coating of the semiconductor material 54B to a surface. To do this, the semiconductor material 54B is first blended into a polymer or a polymerizable mixture of monomers. Next, the mixture is then spin coated, ink jetted, or otherwise applied as a thin layer over a surface (e.g., of a film, substrate or vehicle component). Monomer mixtures can be polymerized (cured) on the surface after application. Using this approach, it may be important to assure that the polymer or monomer mixture is lipophilic (non-polar) if organic soluble semiconductor material 54B is being used. Conversely, if water-soluble photoluminescent semiconductor material 54B is being used, the polymer or monomers may be hydrophilic (water soluble).

In this exemplary non-limiting embodiment, a stability layer 100 is positioned on an opposite side of the semiconductor layer 54 from the support structure 58. The stability layer 100 may be polymeric or other coating configured to protect the semiconductor layer 54 from environmental damage (e.g., due to dirt, moisture, debris, access heat). The stability layer 100 may be composed of silicone, polyisoprene, polybutadiene, chloroprene, butyl rubber, nitrile rubber, fluorosilicate, fluoroelastomers, ethylene vinyl acetate, other soft polymeric materials and/or combinations thereof.

Although shown as directly coating components of the braking assembly 18, other areas of the wheel area of the vehicle 10 could instead, or additionally, include the indicator 50, such as, for example, the rim 26. In such an example, the rim 26 would still take on thermal energy during braking. The indicator would still illuminate in response to thermal energy from the braking components heating even if the indicator were on the rim 26.

Features of the disclosed embodiments can include an indicator that absorbs a first emission and emits a second, different emission. The second emission can provide a visual indication representing thermal energy within the braking component. The second emission can instead or additionally provide decorative accent lighting at a wheel area of the vehicle without using electric power or a lamp module. As braking components cool when the vehicle is not braking, the accent lighting can gradually fade. The indicator can be coated or painted onto an area of a braking component or a surrounding area.

In some specific examples, the color of the accent lighting reflects a temperature corresponding to thermal energy within the braking assembly. Thus, a visual indication of a braking component temperature is viewable from an exterior of the vehicle.

For example, the indicator could include quantum dots of different colors formulated to be excited by infrared radiation of different wavelengths. The color emitted by the indicator then changes depending on a temperature of the braking components. The color that varies in response to a temperature of the braking components can help indicate temperatures of the braking components. This could be useful to, for example, identify overheating or malfunction of the braking components during vehicle race. In such examples, a yellow color emitted from the braking components could correspond to the thermal energy within the braking components being at a normal level, an orange color could represent a relatively high level of thermal energy, and a red color could represent a braking component that includes an overheated amount of thermal energy. This color designation would help, for racing applications, pit crew members to observe a temperature of braking components during a race.

Notably, wire harnesses, wiring, and other components are not needed with the indicator of the present invention.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. A vehicle brake assembly, comprising:
a brake component configured to emit a first emission having a wavelength greater than a wavelength of visible light; and
an indicator adjacent the brake component, the indicator including a semiconductor layer configured to absorb the first emission and emit a second, different emission.

2. The vehicle brake assembly of claim 1, further comprising the brake component as a support structure of the indicator, wherein the indicator is secured directly to the brake component that emits the first emission.

3. The vehicle brake assembly of claim 1, wherein the semiconductor layer comprises a plurality of quantum dots.

4. The vehicle brake assembly of claim 3, wherein the plurality of quantum dots are suspended in polymethylmethacrylate.

5. The vehicle brake assembly of claim 1, wherein the first emission has a wavelength greater than about 800 nm.

6. The vehicle brake assembly of claim 1, wherein a wavelength of the first emission is longer than a wavelength of the second emission.

7. The vehicle brake assembly of claim 1, wherein the indicator is secured directly to a brake rotor, wherein the brake rotor is the brake component configured to emit the first emission.

8. The vehicle brake assembly of claim 1, wherein the indicator is secured directly to a brake caliper.

9. The vehicle brake assembly of claim 1, wherein the indicator is secured directly to a wheel.

10.-18. (canceled)

19. The vehicle brake assembly of claim 1, wherein the thermal radiation is infrared radiation.

20. The vehicle brake assembly of claim 3, wherein the indicator is secured directly to a brake caliper.

21. The vehicle brake assembly of claim 1, further comprising a tire mounted to a rim, and a rotor separate from the tire and the rim, wherein the brake component is the rotor, and the indicator is secured directly to a portion of the rotor.

22. The vehicle brake assembly of claim 21, further comprising a plurality of openings of the rim that are circumferentially distributed about an axis of rotation of the rim, the indicator visible through the openings.

23. The vehicle brake assembly of claim 1, wherein the brake component includes a first area coated by the indicator and a second area uncoated by the indicator, the coated area not contacted by brake pads during braking, the uncoated area contacted by the brake pads during braking.

24. A vehicle assembly, comprising:
a brake component that emits thermal radiation; and
an indicator including a semiconductor layer that emits visible light when excited by the thermal radiation.

25. The vehicle assembly of claim 24, wherein the indicator is secured directly to a portion the brake component that emits thermal radiation.

26. The vehicle assembly of claim 25, further comprising an adhesive layer of the indicator that adhesively secures the indicator to the portion of the brake component.

27. The vehicle assembly of claim 25, wherein the brake component is a rotor, and further comprising at least one brake pad configured to contact the rotor to brake the rotor, wherein the indicator is not contacted by the at least one brake pad during braking.

28. The vehicle assembly of claim 24, wherein the semiconductor layer comprises a plurality of quantum dots, wherein the indicator is secured directly to a brake caliper.

29. The vehicle assembly of claim 24, wherein the thermal radiation has a wavelength greater than 800 nm.
